(19) United States
(12) Patent Application Publication
(10) Pub. No.: US 2015/0095335 A1
(43) Pub. Date: Apr. 2, 2015

(54) CHANGE MANAGEMENT SYSTEM IN A PROCESS CONTROL ARCHITECTURE

(71) Applicant: Fisher-Rosemount Systems, Inc., Round Rock, TX (US)

(72) Inventors: Mark Alvin L. Reyes, Meycauayan City (PH); Jon D. Westbrock, Rosemount, MN (US); Ram Ramachandran, Austin, TX (US)

(73) Assignee: Fisher-Rosemount Systems, Inc.

(21) Appl. No.: 14/495,129

(22) Filed: Sep. 24, 2014

Related U.S. Application Data
(60) Provisional application No. 61/883,439, filed on Sep. 27, 2013.

(51) Int. Cl. G06F 17/30; G05B 15/02

(52) U.S. Cl. CPC G06F 17/30598; G05B 15/02
USPC 707/737

(57) ABSTRACT

A computer-implemented system and method of managing changes to a process control system are provided. The method includes obtaining a plurality of changes to the process control system. The plurality of changes are categorized into a plurality of categories. Each change is assigned an initial status. The categorized changes are displayed with their associated status to a user to receive user action relative to at least one categorized change. A status of the at least one categorized change is stored.

### CROSS-REFERENCE TO RELATED APPLICATIONS

The present application is based on and claims the benefit of U.S. Provisional Patent Application Ser. No. 61/883,439, filed Sep. 27, 2013, the content of which is hereby incorporated by reference in its entirety.

### BACKGROUND

Process control systems, such as distributed or scalable process control systems are used to control chemical, petroleum or other processes. Such systems typically include one or more process controllers communicatively coupled at least one host or operator workstation and to one or more field devices via analog, digital or combined analog/digital buses. The field devices, which may be, for example, valves, valve positioners, switches and process variable transmitters (e.g., temperature, pressure and flow rate sensors), perform functions within the process such as opening or closing valves and measuring process parameters. The process controller receives signals indicative of process measurements made by the field devices and/or other of information pertaining to the field devices, and uses this information to implement a control routine and then generates control signals which are sent over the buses to the field devices to control the operation of the process. Information from the field devices and the controller is typically made available to one or more applications executed by the operator workstation(s) to enable an operator to perform any desired function with respect to the process. such as viewing the current state of the process and/or modifying the operation of the process.

One example of such a control system is that sold under the trade designation, DeltaV™ control system, available from Emerson Process Management, of Austin, Tex. Generally speaking, DeltaV™ is a digital automation system for managing and controlling industrial processes. Many modern industrial processes are instrumented with controllers and various field devices that automatically perform physical functions in a field according to a certain control strategy. Many control strategies are highly complex, and teams of engineers, operators, and technicians require comprehensive software solutions such as DeltaV™ to manage process plants that implement such control strategies. Today, plant operators in such diverse industries as life sciences, biotechnologies, petroleum, gas, chemicals, pulp and paper, and food and beverage run DeltaV™ in numerous process plants.

DeltaV™ includes multiple applications stored within and executed by different hosts in a process installation. Such hosts include various workstations located at diverse places within a process plant. If desired, DeltaV™ applications may also be networked across several facilities or process control plants. For example, a configuration application, which resides in one or more operator workstations, enables users to create or change process control modules and download these process control modules via a data communication channel or pathway to dedicated distributed controllers. As another example, viewing applications, which may be run on one or more operator workstations, receive data from a controller application via a data communication channel or pathway and display this data to process control system designers, operators, or users using user interfaces of the workstations.

When a digital automation system or any other system used in the process control industry is purchased, there may be software updates that subsequently become available. These software updates may fix problems with previous versions, improve operation or efficiency, improve user interaction with the system or many other possible benefits. Additionally, the manufacturer of the digital automation system may become aware of and address various issues after the digital automation system has been deployed. In such instances, the manufacturer may issue one or more Knowledge Base Articles (KBAs) that detail the issue and provide a description of an appropriate remedy. Such software updates and/or KBAs may be applicable to any device or system operating in the process control environment including, without limitation, workstations, controllers, I/O hardware, field devices, et cetera.

Given the vast number of field devices and software modules that may be deployed in a given process installation, the acquisition, evaluation and selective implementation of the various updates and KBAs is time-consuming but required. Providing a system and method that improved the process would benefit the process control industry by facilitating faster implementation of relevant updates and KBAs. Since both updates and KBAs essentially change the system in some way or another, they are referred to generically herein as “changes.”

### SUMMARY

A computer-implemented system and method of managing changes to a process control system are provided. The method includes obtaining a plurality of changes to the process control system. The plurality of changes are categorized into a plurality of categories. Each change is assigned an initial status. The categorized changes are displayed with their associated status to a user to receive user action relative to at least one categorized change. A status of the categorized change is stored.

### BRIEF DESCRIPTION OF THE DRAWINGS

FIG. 1 is a diagrammatic view of a process control and monitoring system with which embodiments of the present invention are particularly useful.

FIG. 2 is an exemplary screenshot of a user interface allowing a user to view and take action relative to one or more updates or KBAs in accordance with an embodiment of the present invention.

FIG. 3 is a diagrammatic screenshot of a user interface allowing a user to take action relative to one or more updates or KBAs in accordance with an embodiment of the present invention.

FIG. 4 is a diagrammatic hierarchical view of update and KBA storage in accordance with an embodiment of the present invention.

FIG. 5 is a screenshot of an exemplary user interface allowing a user to enter notes relative to one or more updates or KBAs in accordance with an embodiment of the present invention.

FIG. 6 is a flow diagram of a method of obtaining software updates and KBAs relative to a process installation in accordance with an embodiment of the present invention.

FIG. 7 is a diagrammatic view of a computing environment on which one or more update applications may execute in accordance with an embodiment of the present invention.

### DETAILED DESCRIPTION OF ILLUSTRATIVE EMBODIMENTS

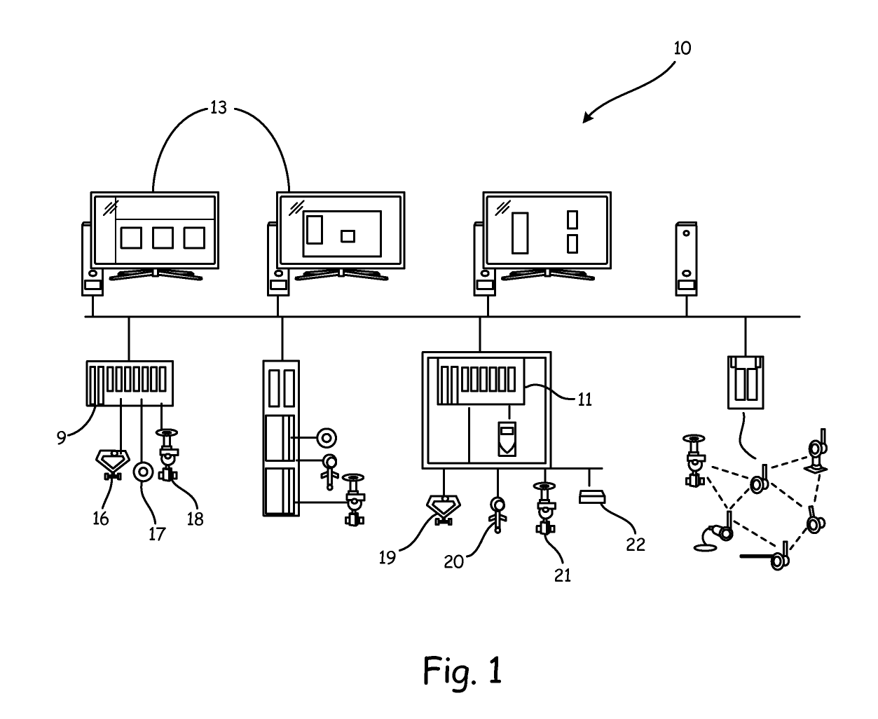

FIG. 1 is a diagrammatic view of a process control and monitoring system with which embodiments of the present invention are particularly useful. Process control and monitoring system 10 includes one or more process controllers 9, 11 coupled to one or more host workstations or computers 13 (which may include any suitable computing devices) each having a user interface that includes a screen and a user input device. Process controllers 9, 11 are coupled to field devices 16-22 through suitable input/output cards or modules. Each of process controllers 9, 11 may be any suitable process controller. Process controllers 11, as well as the other communication interface devices shown in FIG. 1, are communicatively coupled to host workstations 13 via an Ethernet connection or any suitable data communication connection. Process controllers 9, 11 are also communicatively coupled to field devices 16-22 using a suitable process communication protocol, such as the FOUNDATION™ Fieldbus protocol, the HART® protocol, et cetera.

Field devices 16-22 may be any suitable field devices, such as process variable transmitters, valves, positioners, et cetera. Input/output cards or modules may be any suitable type of devices that conform to a standard process communication protocol. For example, process controller 9 may include a HART® I/O card that communicates in accordance with the HART® protocol with field devices 16, 17, and 18. Additionally, process controller 11 may include a FOUNDATION Fieldbus card allowing a process controller 11 to communicate in accordance with the FOUNDATION™ Fieldbus protocol to intelligent field devices 19, 20, 21, and 22.

The process controllers include a processor that implements or oversees one or more process control routines (stored in memory) and communicates with field devices 16-22 and the host workstations 13 to control a process in any desired manner.

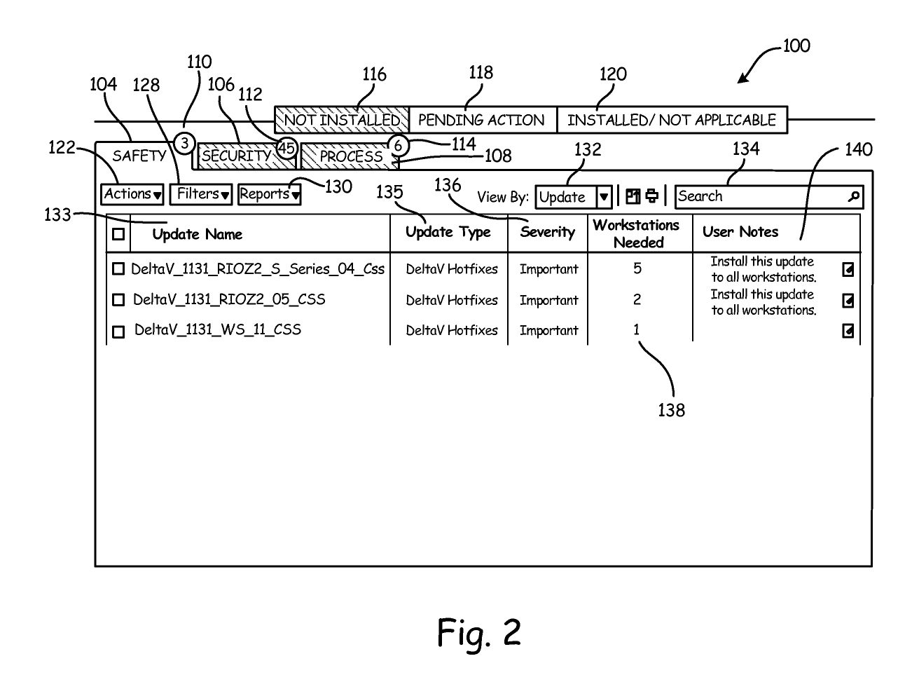

FIG. 2 illustrates a screenshot 100 of a user interface 102 displayed by any suitable workstation or other device in or communicatively coupled to the process installation. User interface 102 allows a user to view one or more updates and/or KBAs in accordance with an embodiment of the present invention. User interface 102 may be generated locally by any of workstations 13. However, user interface 102 may be also generated remotely by a server operating at a remote location, such as a manufacturer facility, and coupled to the process control installation via a suitable data communication network, such as the internet. Accordingly, user interface 102 may be generated locally at the process control installation or remotely via a software service operating in the cloud.

In the embodiment illustrated in FIG. 2, all software updates and KBAs applicable to the user's installation are assigned to one of three categories and provided with a specific status.

The three categories shown in the embodiment illustrated in FIG. 2 include safety, security, and process. Additionally, the status identifier of the various software updates and KBAs include, in one embodiment, “Not Installed”; “Pending Action”; “Installed/Not applicable”; “For Review”; and “Action Complete.” In one embodiment, the various categories of updates and KBAs are viewable in a tabbed view. Accordingly, interface 102 includes safety tab 104, security tab 106, and process tab 108. FIG. 2 illustrates safety tab 104 as currently being selected with security tab 106 and process tab 108 being greyed out as non-selected. If a user should click on either of tabs 106 or 108, that tab then becomes the selected tab and the remaining tabs are subsequently greyed or deemphasized. In one embodiment, each view shows the number of updates and KBAs that are currently not installed for each category. For example, safety tab 104 has indicator 110 in the form of a circle with the number 3 located inside. This indicates that there are three safety-related updates or KBAs that are currently not installed. Thus, the user has selected safety tab 104 and the three individual updates are listed under the column “Update Name.” Similarly, security tab 106 includes an indicator 112 indicating the number of security-related updates or KBAs that have not been installed. As shown in FIG. 2, there are 45 such updates or KBAs. Finally, process tab 108 has an indicator 114 displaying that there are 6 process-related updates or KBAs that are currently not installed. In one embodiment, the indicators 110, 112, and 114 always indicate a number of “Not Installed” updates or KBAs in that particular category. In another embodiment, the indicators provide an indication of the number of updates or KBAs that have a status that matches the selected status (FIG. 2 illustrates that the currently-selected status is “Not Installed” since tab 116 is highlighted). Accordingly, if a user were to select pending action tab 118, in one embodiment, identifiers 110, 112, and 114 would indicate the number of updates or KBAs that have pending action. Finally, the user can also select installed/not applicable tab 120 and view various updates and KBAs that have already been installed or have been deemed not applicable.

This fundamental categorization of updates and KBAs as being safety related, security-related, or process-related significantly simplifies the manner in which such updates and KBAs are reviewed and implemented. This is because the various categories are generally not of the same priority. Safety is illustrated as the left-most tab indicating that it is of the highest priority. Security is becoming another high priority in the process control industry. Finally, process-related updates and KBAs are all other updates and KBAs that are required in order to ensure efficient operation of the process plant. Thus, all incoming software updates and KBAs are aligned with these various priorities by providing the tabs illustrated in FIG. 2. Additionally, once a given update or KBA has been read or otherwise considered, the user interface may depict the given update or KBA differently, such as with a different color and/or size of characters. However, those skilled in the art will recognize other ways in which updates and/or KBAs that have been read or accessed can be indicated as such.

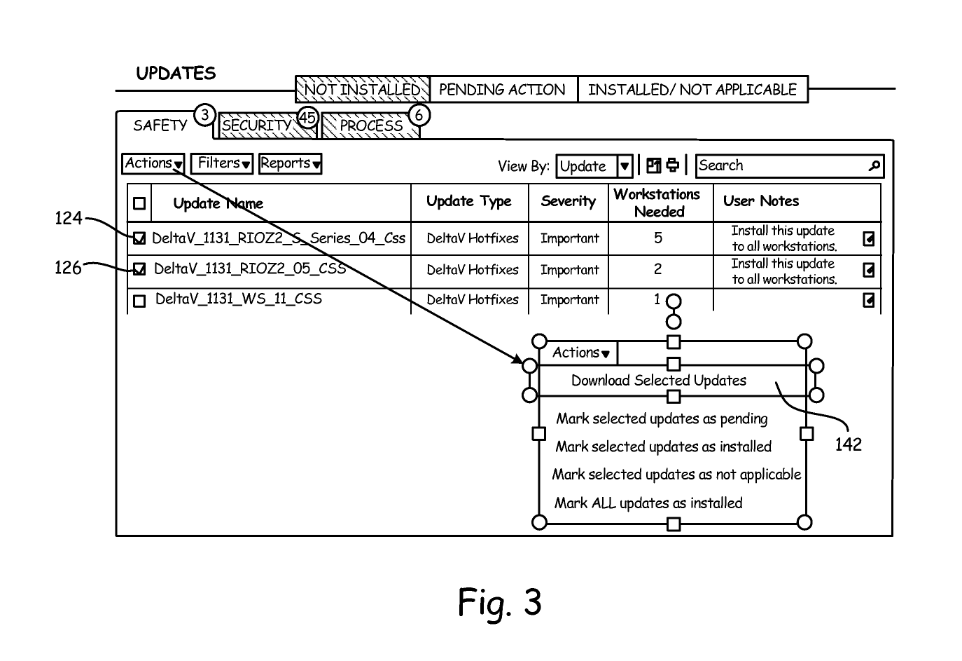

FIG. 2 illustrates a user interface component 122 that, when actuated by a user, provides one or more potential actions that may be taken relative to one or more of the updates or KBAs. When a user selects element 122, a dialog (shown in FIG. 3) is generated listing the various actions that can be taken. In FIG. 3, these actions include: downloading selected updates; marking selected updates as Pending; marking selected updates as Installed; marking selected updates as Not Applicable; and marking ALL updates as Installed. Those skilled in the art will recognize that additional actions relative to one or more updates or KBAs can be provided in accordance with embodiments of the present invention. Additionally, these actions are taken relative to the updates or KBAs which are selected, as illustrated by check marks 124, 126 in FIG. 3. However, regardless of the updates selected with check marks 124, 126, if the selected action is indicated as applying to all updates then it will be so applied. For example, “Mark ALL updates as Installed” will be applied to all updates regardless of check box selections.

Referring back to FIG. 2, another user interface element 128 allows the user to apply one or more filters to the listing of updates and KBAs. This is particularly useful in situations where the number of updates and KBAs is large the user wishes to only address a certain subset in a particular session. Applicable filters can apply various criteria and combinations of criteria to the listing of updates and KBAs in order to surface or otherwise display a reduced set. Such criteria can include, without limitation: release date of the update or KBA; model number of the device or software application to which the update or KBA is applicable; keywords; version information; and priority, among others. An additional user interface element 130 is also provided to generate one or more reports based upon the various updates and KBAs of the selected category. These reports may allow supervisors or other interested persons or entities to review incoming software updates and KBAs so as to determine which require action and which do not. Additionally, the report element 130 can be used to generate a checklist that can be used by technicians or other operators to keep track of which software updates have been installed on individual host workstations 13 as the updates are installed.

FIG. 2 also provides a view selector field 132 that allows a user to arrange or sort the listing of updates and KBAs in any suitable manner. In the embodiment shown in FIG. 2, the view selector field 132 is set to “View By: Update.” However, those skilled in the art will recognize that any other suitable order or view selector can be used in accordance with embodiments of the present invention. Examples include viewing by update type; viewing by severity, viewing by the number of workstations needing the update or KBA, or any other suitable sorting criteria. By suitable sorting the various updates and KBAs, any connections between a given update and a KBA will be readily apparent to the user. Additionally, the various updates and KBAs can be organized by workstation thus providing the user with the ability to determine that workstation X requires Y updates and KBAs.

User interface 102 also includes a search box 134 that is configured to receive user input and search the various updates and KBAs based upon the user-provided input. In one embodiment, this search may be across merely the updates and KBAs having the same category as the currently-active tab (such as safety tab 104). In another embodiment, the search may be performed across all updates and KBAs that have been installed or deemed not applicable; are currently pending; or are not installed.

Screenshot 100 depicts an orderly listing of the various updates that are safety-related. Specifically, update names:, “DeltaV_{—}1131_RIOZ2_S_S_Series_{—}04_CSS; DeltaV_{—}1131_RIOZ2_{—}05_CSS ; and DeltaV_{—}1131_WS_{—}11_CSS” are provided. The update type 135 for each update is listed next to update name 133 column. For the three updates illustrated in FIG. 2, the update type is DeltaV™ Hotfixes. Additional types of updates or KBAs include operating system updates, antivirus updates, malware updates, firewall updates, or any other suitable type of update. A severity indicator 136 is provided next to update type column 135. The severity indicator 136 indicates the severity of the displayed update or KBA. Examples of severity indicators parameters include, without limitation: recommended, important, priority, critical, suggested, best practice, or other suitable indications that may be provided by the manufacturer or generator of the update or KBA. In one embodiment, the importance indicators are prioritized such that they may be displayed in accordance with their priority by setting View By window 132 to indicate severity. At column 138, the user is provided with a listing of the number of workstations in the user's process installation that would require the indicated update or KBA. In one embodiment, the number itself is selectable by the user such that selecting the number will generate a listing of individual workstations requiring the particular update or KBA. In the example shown, DeltaV_{—}1131_RIOZ2_S_Series_{—}04_CSS has five workstations that need the update. In accordance with embodiments of the present invention, the user has the ability to mark the software updates and/or KBAs as installed or not applicable at the granularity of the individual workstation (i.e., installed on workstation X) or all workstations (i.e., installed on all workstations).

FIG. 2 also shows user notes column 140 that allows the user to generate and save notes with respect to each of the displayed updates or KBAs. In the embodiment shown in FIG. 2, the user has reviewed two of the DeltaV_hotfix updates and decided that such updates need to be installed on all workstations. Such notes are helpful for communicating with the members of the teams of technicians or operators that are tasked with implementing such updates or KBAs.

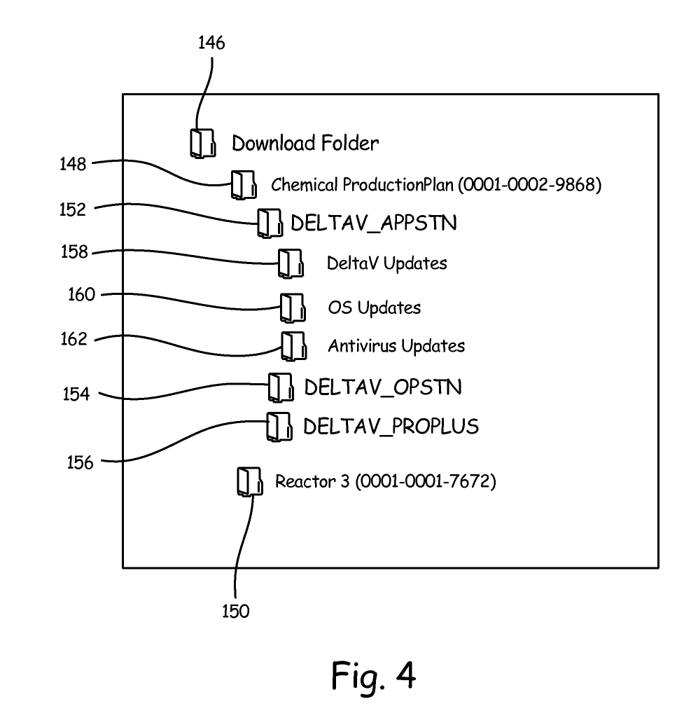

FIG. 3 is a diagrammatic screenshot of a user interface provided when a user selects user interface element 122 in FIG. 2. As shown in FIG. 3, one of the available actions is to “download selected updates” 142 with respect to the updates selected via checks 124 and 126. Once the action has been initiated, the update component, which may be a component of the same computing device that is generating the user interface, or a different device, will request and download the selected updates from a suitable update source, such as a manufacturer server, or other suitable third-party provider. When the updates have been successfully downloaded, they are stored, in one embodiment, into an hierarchical arrangement of folders, as illustrated in FIG. 4. Providing the software updates and KBAs automatically organized into the hierarchical folders, such as that shown in FIG. 4, allows all updates for one or more workstations to be easily copied to a mobile storage device for installation on the selected workstations. As shown in FIG. 4, download folder 146 has two child folders 148 (Chemical Production Plan (0001-0002-9868)), and 150 (Reactor 3 (0001-0001-7672)). Additionally, under subfolder 148 there are three distinct subfolders: subfolder 152, entitled DELTAV_APPSTN; subfolder 154, entitled DELTAV_OPSTN; and subfolder 156 entitled DELTAV_PROPLUS. Further still, subfolder 152 has three additional subfolders 158, 160, and 162. Subfolder 158 is directed to and stores DeltaV™-specific updates and KBAs. Subfolder 160 stores operating system updates and subfolder 162 is directed to antivirus/malware updates.

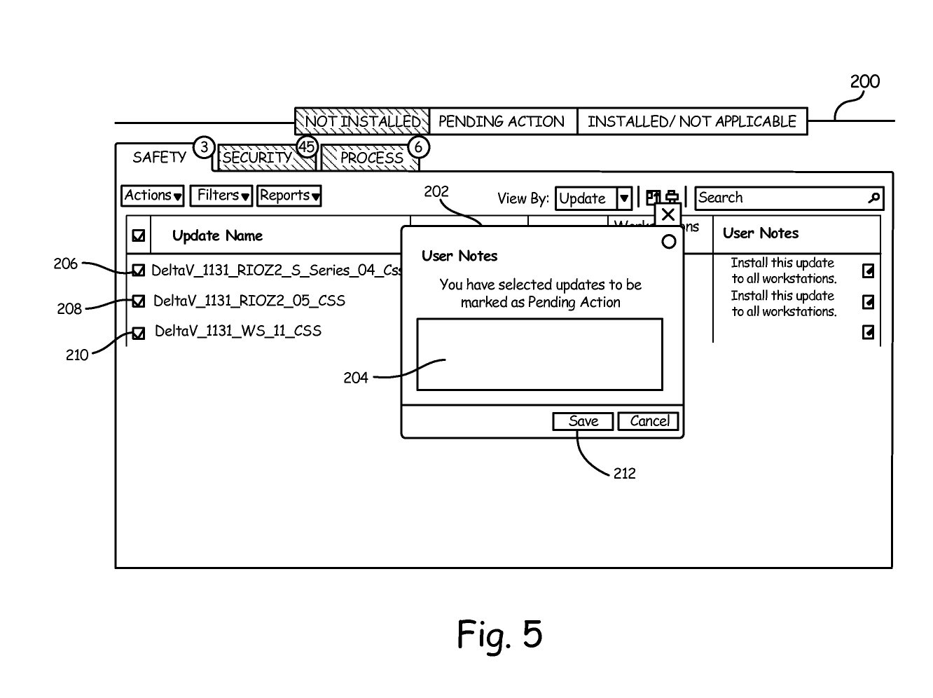

FIG. 5 is a screenshot of a user interface allowing a user to enter notes relative to one or more selected updates and/or KBAs. Specifically, user interface 200 includes user notes dialog 202 that allows a user to enter text into box 204 that will be saved relative to the updates or KBAs for which selections (checks 206, 208, and 210) are provided. Once the user has entered the appropriate text, the user notes are saved by selecting save button 212. In this way, user can add notes to help keep track of decisions that have been made on selecting, downloading, and/or installing the appropriate software updates and KBAs for the system.

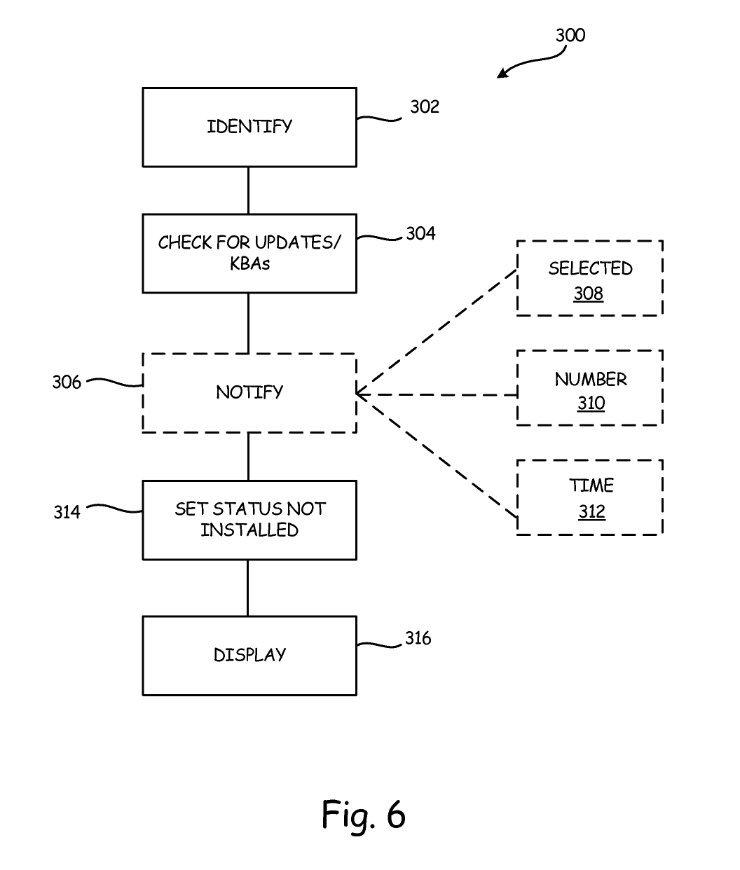

FIG. 6 is a flow diagram of a method of obtaining software updates relative to a process installation in accordance with an embodiment of the present invention. Method 300 begins at block 302 where software and/or hardware information relative to one or more workstations or other devices operating in the process control installation is identified. Next, at block 304, a system, such as a workstation located in the process control installation, or a remote server, checks one or more sources for updates and KBAs that are applicable to the software and/or hardware information identified at block 302. The updates may be downloaded automatically, or may simply be indicated as available to a user through a user interface. Automatically downloading all updates trades some storage space for the ability to quickly apply and interact with updates once the user begins addressing them. In embodiments where less than all updates are automatically downloaded, an index or listing of all updates can be downloaded, such that a report or listing of updates that have been already downloaded can be provided along with a listing of updates that still need to be downloaded. KBAs are not downloaded in the sense that updates are downloaded. Instead, a listing of applicable KBAs is obtained, from any suitable source, and provided in user interface 102.

At block 306, a notification may be generated relative to the available updates and KBAs identified at block 304. This notification can be separate from the surfacing of the various updates and KBAs within the user interfaces described above. In particular, the notification may be in the form of an e-mail, SMS, or other suitable message informing an operator or responsible party of the availability of one or more updates or KBAs. Additionally, the notification(s) may only be provided for a selected software or assets, as indicated at dashed block 308. Additionally, a notification may be generated based purely on the number of updates and KBAs that are available. For example, if more than ten updates or KBAs are available, a suitable notification 310 may be generated. Further, the age of the available update and KBA may be used to select whether to generate such a notification, as illustrated at dashed block 312. Certainly, various combinations of these criteria as well as other suitable criteria may be used in order to decide whether and how to generate such notifications to an operator or responsible party.

Next, at block 314, the status of all applicable updates and KBAs is set to “Not Installed.” Finally, at block 316, the updates and KBAs are displayed to a user. This display may be as shown in FIG. 2 where the various “Not Installed” updates and KBAs are broken into three distinct categories which are prioritized for operator action. Notifications on the number of safety, security and process-related software updates and KBAs that have not been acted upon can also be provided, as appropriate. Such notification can be done prior to display to a user in an update tool, or as a function provided by an update tool. Additionally, notifications of software updates and KBAs that have not been addressed in a timely manner can also be the subject of suitable notifications. Such updates can be provided to any suitable responsible parties, such as an operations manager.

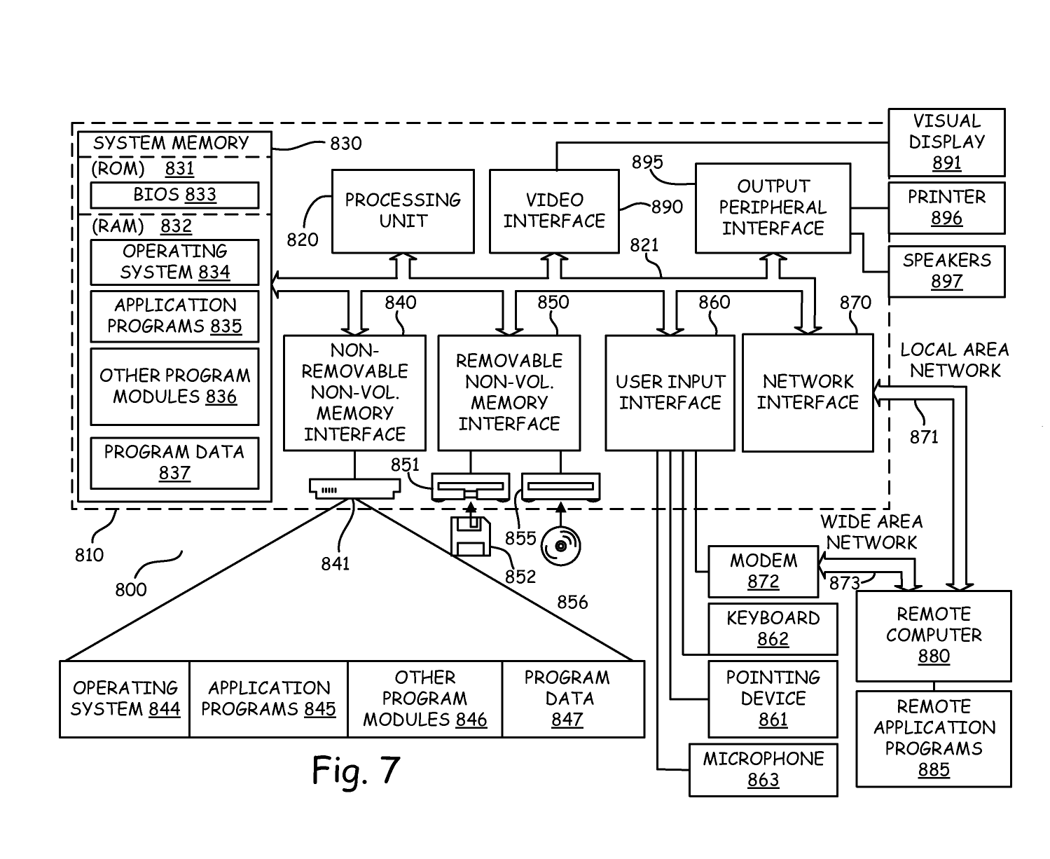

FIG. 7 is a diagrammatic view of a computing environment on which one or more update applications may execute in accordance with an embodiment of the present invention. Additionally, it is expressly contemplated that the process control installation may comprise multiple computing devices working cooperatively or individually to execute one or more individual software applications. With reference to FIG. 7, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using a variety of but architectures. Memory and programs described with respect to FIG. 2 can be employed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in a manner so as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (PS SPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network—LAN, or a wide area network—WAN) to one or more remote computers, such as a remote computer 880. When used in a LAN networking environment, computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in the remote memory storage device. FIG. 7 illustrates, for example, that remote application programs 885 can reside on remote computer 880.

Although the present invention has been described with reference to preferred embodiments, workers skilled in the art will recognize that changes may be made in form and detail without departing from the spirit and scope of the invention.

What is claimed is:

1. A computer-implemented method of managing changes to a process control system, the method comprising:
obtaining a plurality of changes to the process control system;
categorizing the plurality of changes into a plurality of categories;
assigning an initial status to each change;
displaying the categorized changes with their associated status to a user to receive user action relative to at least one categorized change; and
changing a status of the at least one categorized change.

2. The computer-implemented method of claim 1, wherein displaying the categorized changes includes listing the categorized changes in a user interface of the computer, with each category being displayed separately.

3. The computer-implemented method of claim 1, wherein the categories are prioritized.

4. The computer-implemented method of claim 3, wherein a first category is safety-related.

5. The computer-implemented method of claim 4, wherein a second category is security-related.

6. The computer-implemented method of claim 5, wherein the first category has a higher priority than the second category.

7. The computer-implemented method of claim 6, wherein the categories are displayed in different tabs.

8. The computer-implemented method of claim 7, wherein the tabs are arranged in accordance with the priority of the categories with which they are associated.

9. The computer-implemented method of claim 1, and further comprising a user interface element allowing the user to take action relative to at least one change for a plurality of workstations.

10. The computer-implemented method of claim 9, wherein the at least one change comprises a plurality of changes.

11. The computer-implemented method of claim 1, wherein the plurality of changes includes at least one software update.

12. The computer-implemented method of claim 1, wherein the plurality of changes includes at least one knowledge base article.

13. The computer-implemented method of claim 1, and further comprising providing a user interface element configured to receive user notes relative to at least one change.

14. A computer system for managing changes relative to a process control system, the computer system comprising:
a memory configured to store information related to a plurality of changes; and
a processor coupled to the memory and configured to generate a user interface to interact with a user to review and selectively implement the changes; and
wherein the user interface is configured to allows the user to view a plurality of changes relative to the process control system, the plurality of changes being arranged based on categories and status.

15. The computer system of claim 1, wherein the computer system is remote from the process control system and communicatively coupled thereto by a communication channel.

16. The computer system of claim 14, and further comprising a storage device storing the changes in a hierarchical folder structure.

17. The computer system of claim 14, wherein the categories include safety, security and process.

18. The computer system of claim 14, wherein the user interface is configured to display the categories based relative priority.

19. The computer system of claim 14, wherein the status includes not installed, pending, and installed.

20. The computer system of claim 14, and further comprising a notification component configured to selectively generate a notification to a responsible party based on a criteria relative to the plurality of changes.
